(19) United States
(12) Patent Application Publication
(10) Pub. No.: US 2025/0289470 A1
(43) Pub. Date: Sep. 18, 2025

(54) Method and Apparatus for Controlling Autonomous Driving of Autonomous Vehicle

(71) Applicants: Hyundai Motor Company, Seoul (KR); Kia Corporation, Seoul (KR)

(72) Inventors: Su Young Choi, Hwaseong-Si (KR); Sung Kwan Kim, Hwaseong-Si (KR)

(21) Appl. No.: 18/886,057

(22) Filed: Sep. 16, 2024

(30) Foreign Application Priority Data
Mar. 18, 2024 (KR) 10-2024-0037283

(51) Int. Cl. B60W 60/00; B60W 50/00; G06V 20/56

(52) U.S. Cl. CPC B60W 60/0011; B60W 50/0097; G06V 20/588; B60W 2420/403; B60W 2552/53; B60W 2556/40

(57) ABSTRACT

A method performed by a vehicle for controlling autonomous driving of the vehicle is introduced. The method may include steps of obtaining training data comprising information about a first drivable area, outputting, based on the information about the first drivable area, a first driving path in the first drivable area, determining, based on the first driving path and the training data, a driving path loss, updating, based on the driving path loss, at least one of parameters associated with the outputting the first driving path, obtaining, based on the updating the at least one of parameters, test data comprising information about a second drivable area for testing, outputting, based on the information about the second drivable area for testing, a second driving path for testing in the second drivable area for testing, and controlling, based on the second driving path for testing, autonomous driving of the vehicle.

### CROSS-REFERENCE TO RELATED APPLICATION

This application claims the benefit of priority to Korean Patent Application No. 10-2024-0037283, filed in the Korean Intellectual Property Office on Mar. 18, 2024, the entire contents of which are incorporated herein by reference.

### TECHNICAL FIELD

The present disclosure relates to a method and an apparatus for controlling autonomous driving of an autonomous vehicle.

### BACKGROUND

Recently, with the rapid development of autonomous driving technology, the need to efficiently generate a driving path has emerged Various methods are being explored for generating a driving path.

However, because a long calculation time may be consumed for generating a driving path, there is a need for a driving path generation scheme that is suitable for an autonomous driving moving object (e.g., a vehicle) with limited computing resources.

Thus, considering the rapidly changing autonomous driving environment, a method for safely and cost-effectively generating a real-time driving path is studied.

### SUMMARY

According to the present disclosure, a method performed by a vehicle for controlling autonomous driving of the vehicle, the method comprising obtaining training data comprising information about a first drivable area, outputting, based on the information about the first drivable area, a first driving path in the first drivable area, determining, based on the first driving path and the training data, a driving path loss, updating, based on the driving path loss, at least one of parameters associated with the outputting the first driving path, obtaining, based on the updating the at least one of parameters, test data comprising information about a second drivable area for testing, outputting, based on the information about the second drivable area for testing, a second driving path for testing in the second drivable area for testing, and controlling, based on the second driving path for testing, autonomous driving of the vehicle.

The method, wherein the information about the first drivable area comprises information about a boundary line of the first drivable area.

The method, wherein the information about the boundary line of the first drivable area comprises information about a plurality of first boundary points on a first boundary line of the first drivable area, and a plurality of second boundary points on a second boundary line of the first drivable area.

The method, further comprising generating, based on a training data generation model and the information about the first drivable area, the training data, wherein the training data comprises an improved driving path corresponding to the first drivable area, and wherein the information about the first drivable area is input before obtaining the training data.

The method, wherein the generating the training data comprises generating, based on a quadratic programming scheme, the improved driving path.

The method, wherein the information about the first drivable area is obtained based on at least a portion of first driving data generated as a moving object travels on a road, and second driving data generated based on a driving simulation process.

The method, wherein the obtaining the test data comprises generating, based on at least a portion of a driving image obtained from an image sensor and high definition map information, the test data, wherein the at least the portion of the driving image is obtained before obtaining the test data.

The method, wherein the generating the test data comprises generating, based on driving scenario information, the test data.

The method, further comprising outputting coordinates of prediction points on the first driving path, wherein the driving path loss is associated with a value representing how far the prediction points are from target values.

According to the present disclosure, an apparatus for controlling autonomous driving of a vehicle, the apparatus comprising at least processor, and a memory storing instructions, when executed by the at least one processor, cause the apparatus to obtain training data comprising information about a first drivable area, obtain test data comprising information about a second drivable area for testing, output, based on the information about the first drivable area, a first driving path in the first drivable area, output, based on the information about the second drivable area for testing, a second driving path for testing in the second drivable area, determine, based on the first driving path and the training data, a driving path loss, update, based on the driving path loss, at least one of parameters associated with outputting the first driving path, and control, based on the at least one of parameters, autonomous driving of the vehicle.

The apparatus, wherein the information about the first drivable area comprises information about a boundary line of the first drivable area.

The apparatus, wherein the information about the boundary line of the first drivable area comprises information about a plurality of first boundary points on a first boundary line of the first drivable area, and a plurality of second boundary points on a second boundary line of the first drivable area.

The apparatus, wherein the instructions, when executed by the at least one processor, cause the apparatus to generate, based on a training data generation model and the information about the first drivable area, the training data, wherein the training data comprises an improved driving path corresponding to the first drivable area, and wherein the information about the first drivable area is input before obtaining the training data.

The apparatus, wherein instructions, when executed by the at least one processor, cause the apparatus to generate, based on a quadratic programming scheme, the improved driving path.

The apparatus, wherein the information about the first drivable area is obtained based on at least a portion of first driving data generated as a moving object travels on a road, and second driving data generated based on a driving simulation process.

The apparatus, wherein the obtaining the test data comprises generating, based on at least a portion of a driving image obtained from an image sensor and high definition map information, the test data, wherein the at least the portion of the driving image is obtained before obtaining the test data.

The apparatus, wherein instructions, when executed by the at least one processor, cause the apparatus to obtain the test data by generating, based on driving scenario information, the test data.

The apparatus, wherein instructions, when executed by the at least one processor, cause the apparatus to obtain the test data by obtaining, based on the at least one of parameters associated with outputting the first driving path, the test data.

The apparatus, wherein the information about the boundary line of the first drivable area comprises information about coordinates of boundary points in the boundary line.

The apparatus, wherein instructions, when executed by the at least one processor, cause the apparatus to output coordinates of prediction points on the first driving path.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a learning method according to an example disclosed in the present disclosure;

FIG. 2 shows an example of an operation of a driving path output device according to an example disclosed in the present disclosure;

FIG. 3 shows an example of a result of a learning method according to an example disclosed in the present disclosure;

FIGS. 4A and 4B are examples for comparing a proposed driving path output via a driving path output device with an optimal driving path according to an example disclosed in the present disclosure;

FIG. 5 shows an example of an apparatus according to an example disclosed in the present disclosure; and

FIG. 6 shows an example of a computing system for executing a method for controlling autonomous driving according to an example disclosed in the present disclosure.

With regard to description of drawings, the same or similar denotations may be used f for the same or similar components.

### DETAILED DESCRIPTION

Hereinafter, an example of the present disclosure will be described more fully with reference to the accompanying drawings to such an extent as to be easily embodied by those skilled in the art. However, the present disclosure may be implemented in several different forms and is not limited to the examples described herein.

In describing an example of the present disclosure, when it is determined that a detailed description of a well-known configuration or function may obscure the gist of the present disclosure, a detailed description thereof will be omitted. Parts not related to the description of the present disclosure are omitted in the drawings, and similar parts are denoted by similar reference numerals throughout the specification.

In the present disclosure, when one component is referred to as being “connected with” or “coupled to” another component, it includes not only a case where it is directly connected but also a case where it is indirectly connected with another component and there are other devices in between. In addition, when one component is referred to as “comprising”, “including” or “having” another component, it is meant that the component may further include other components without excluding other components as long as there is no contrary description.

In the present disclosure, the terms such as “first” and “second” are used only for the purpose of distinguishing one component from another, but do not limit an order, the importance, or the like of components unless specifically stated. Thus, a first component in an example may be referred to as a second component in another example in the scope of the present disclosure. Likewise, a second component in an example may be referred to as a first component in another example

In the present disclosure, components which are distinguished from each other are only for clearly explaining each feature, and do not necessarily mean that the components are separated. In other words, a plurality of components may be integrated to form a single hardware or software unit, or a single component may be distributed to form a plurality of hardware or software units. Thus, even if not specifically mentioned, the integrated or separate examples are included in the scope of the present disclosure.

In the present disclosure, components described in various examples may not necessarily: refer to essential components, and some thereof may be selective components. Thus, an example composed of a subset of components described in an example is also included in the scope of the present disclosure. Thus, an example which additionally includes another component in components described in various examples is also included in the scope of the present disclosure.

In the present disclosure, expressions of positional relationships used in the specification, for example, top, bottom, left, and right, are described for convenience of description. When viewing the drawings illustrated in the specification in reverse, the positional relationship described in the specification may be interpreted in the opposite way.

In the present disclosure, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

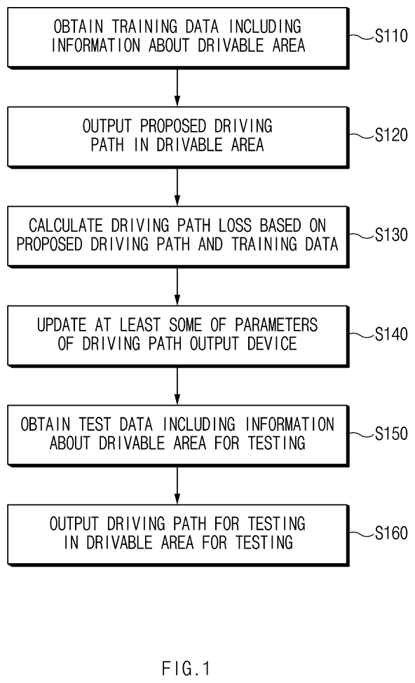

Hereinafter, examples of the present disclosure will be described in detail with reference to FIGS. 1 to 6.

FIG. 1 shows an example of a method for controlling autonomous driving according to an example disclosed in the present disclosure.

First of all, if information about a drivable area is input, a training data generation model may generate training data including an optimal driving path corresponding to the drivable area.

For example, the training data may include information about the drivable area and information about the optimal driving path.

At this time, the drivable area refers to an area where a moving object is movable. For example, the drivable area in a situation where the moving object goes straight may be a specific lane in which the moving object travels. Meanwhile, the drivable area in a situation where the moving object makes a lane change to the right may be a current lane of the moving object and a right lane of the current lane.

For example, the information about the drivable area may be obtained from actual driving data generated as the moving object (e.g., a vehicle) actually travels on the road.

For another example, the information about the drivable area may be obtained from virtual driving data generated as a driving simulation process is performed. For example, the information about the drivable area may be obtained in a road environment which is randomly set on a driving simulation program.

For another example, the information about the drivable area may be obtained from the actual drivable area and the virtual driving data.

At this time, the information about the drivable area may include information about a boundary line (e.g., road lane boundaries, road shoulders, curbs and sidewalks, median strips, parking lot boundaries, off-road paths, construction zones, urban boundaries, toll booths and checkpoints, roundabouts and intersections, etc.) of the drivable area.

For example, the information about the boundary line of the drivable area may include information about a plurality of first boundary points on a first boundary line of the drivable area and a plurality of second boundary points on a second boundary line of the drivable area.

For reference, the first boundary line may be a boundary line located on the left with respect to the moving object, and the second boundary line may be a boundary line located on the right with respect to the moving object.

At this time, the number of the first boundary points on the first boundary line and the number of the second boundary points on the second boundary line may be a predetermined number.

For example, the first boundary points and the second boundary points may be 40, respectively. However, the number of the boundary points is not limited to the number in the training data used in the learning method according to an example disclosed in the present disclosure. For example, the number of the boundary points may vary with generating a driving path up to a few meters ahead and how to set an interval between the boundary points.

For example, if the driving path up to 100 meters ahead is generated and the interval between the boundary points is set to 2 m, the number of the first boundary points and the number of the second boundary points may be 50, respectively.

For another example, if the driving path up to 40 meters ahead is generated and the interval between the boundary points is set to 1 m, the number of the first boundary points and the number of the second boundary points may be 40, respectively.

Furthermore, the optimal driving path may include information about a plurality of optimal or improved points (i.e., target points) on the optimal driving path. A proposed driving path to be described below may include information about a plurality of prediction points on the proposed driving path.

For reference, the proposed driving path and the optimal driving path may include points located in the drivable area. For example, the proposed driving path and the optimal driving path may include points located between the first boundary line and the second boundary line.

At this time, the number of prediction points on the proposed driving path and the number of optimal points on the optimal driving path may be a predetermined number.

For example, the number of the prediction points and the number of the optimal points may be the same as the number of boundary points. For example, if the boundary points are 40, the prediction points and the optimal points may also be 40, respectively. However, the number of the prediction points and the number of the optimal points are not limited to the number. For example, although the boundary points are 40, the prediction points and the optimal points may be 80, respectively.

For example, the training data generation model may generate training data including an optimal driving path based on a quadratic programming scheme.

For reference, the training data generation model may generate an optimal driving path by using information (e.g., the first boundary point and the second boundary point) about the drivable area as the input depending on an objective function of Equation 1 below.

(1/2)z^{T} H z+q^{T} z [Equation 1]

At this time, vector z may be a vector meeting a constraint function such as Equation 2 below.

B (lower bound)≤Az≤c (upper bound) [Equation 2]

For reference, z may be the n-dimensional vector, z^{T} may be the transpose vector of vector z, H may be the n*n dimensional real symmetric matrix, q may be the n-dimensional real vector, q^{T} may be the transpose vector of vector q, A may be the mn dimensional real matrix, b may be the m-dimensional real vector, c may be the m-dimensional real vector, the objective function in Equation 1 above may be the quadratic expression, and the constraint function in Equation 2 above may be the linear expression.

For example, the training data generation model may perform a process of finding a state z for minimizing the objective function in Equation 1 above in a state set meeting the constraint function in Equation 2 above based on the quadratic programming scheme, thus generating an optimal driving path by using the information about the drivable area as the input.

If the training data including the optimal driving path and the information about the drivable area is generated, in S110, an acquisition device 1100 may obtain the training data.

If the training data is obtained in S110, in S120, a driving path output device 1200 may output a proposed driving path in the drivable area with reference to the information about the drivable area.

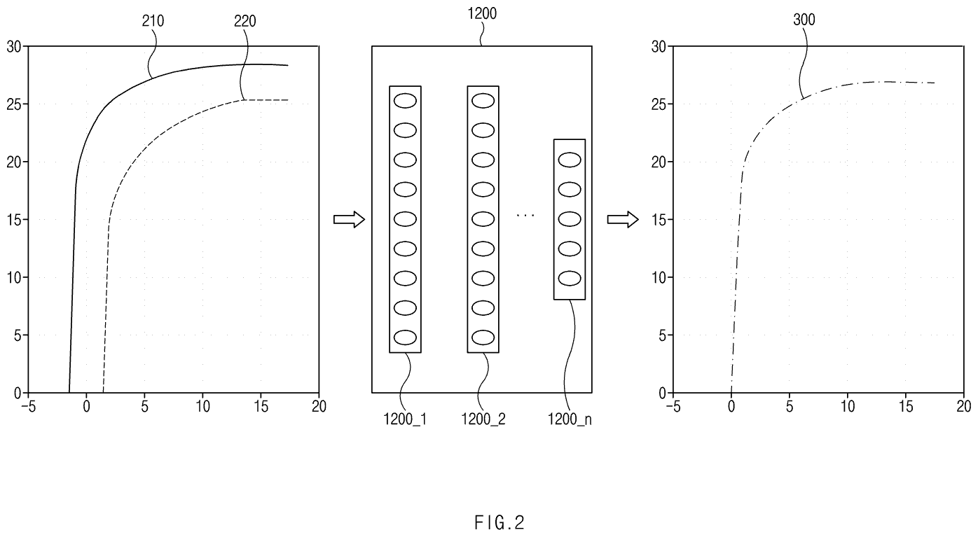

FIG. 2 is a drawing schematically illustrating an operation of a driving path output device 1200.

Referring to FIG. 2, if training data is input, the driving path output device 1200 may output a proposed driving path 300 in a drivable area with reference to information about the drivable area, which is included in the training data, (e.g., a first boundary point on a first boundary line 210 and a second boundary point on a second boundary line 220).

For reference, as described above, the information about the drivable area, which is included in the training data, may be a plurality of boundary points on the boundary lines 210 and 220 of the drivable area and the proposed driving path 300 output by the driving path output device 1200 may be information about a plurality of prediction points on the proposed driving path 300. However, only the first boundary line 210, the second boundary line 220, and the proposed driving path 300 are illustrated for convenience of description in FIG. 2, and boundary points and prediction points are not illustrated in FIG. 2.

For example, as shown in FIG. 2, the driving path output device 1200 may include at least one fully connected layer.

For example, if the driving path output device 1200 includes 4 fully connected layers, the information about the drivable area includes information about 40 first boundary points on the first boundary line and 40 second boundary points on the second boundary line, and the proposed driving path includes information about 40 prediction points, the number of features input to the driving path output device 1200 may be 160 corresponding to (x, y) coordinates of 80 boundary points and the number of features output via the driving path output device 1200 may be 80 corresponding to (x, y) coordinates of 40 prediction points. In other words, input nodes and output nodes of first to third layers 1200_1 to 1200_3 of the driving path output device 1200 may be 160, respectively, input nodes of a last layer 1200_n may be 160, and output nodes of the last layer 1200_n may be 80.

If the proposed driving path is output in S120, in S130, a loss calculation device 1300 may calculate or determine a driving path loss with reference to the proposed driving path and an optimal driving path corresponding to the proposed driving path. For example, a driving path loss may be a cost function or error function indicating how well a specific machine learning model models the proposed driving path. By comparing the predicted values generated by the machine learning model to the actual target values, the loss function may quantify the error or offset difference. The cost function may guide the training process. For example, based on a prediction made by the machine learning model, the cost function may determine a numerical value representing how far the prediction is from the true/correct or target value. The goal of the machine learning is to minimize this cost value (e.g., loss value) by adjusting the machine learning model's parameters during the training phase.

If the driving path loss is calculated or determined in S130, in S140, a parameter update device 1400 may update at least some of parameters of the driving path output device 1200 using the driving path loss.

After the driving path output device 1200 is trained in S140, in S150, an acquisition device 1100 may obtain test data including information about a drivable area for testing.

At this time, the test data may be generated by a test data generator (not shown). The test data generator may generate test data with reference to at least a portion of a driving image obtained from an image sensor and high definition map information.

For example, the test data generator may generate test data including the information about the drivable area for testing based on a free space detection technique, but not limited thereto. For example, the test data generator may change a drivable area for each driving scenario to generate test data.

For example, the test data generator may additionally reference driving scenario information to generate test data including the information about the drivable area for testing.

For example, although there is the same driving environment, the test data generator may generate test data by using a specific lane in which a moving object travels as a drivable area for testing, for a first driving scenario in which the moving object goes straight, whereas the test data generator may generate test data by using a current lane of the moving object and a right lane of the current lane as a driving area for testing, for a second driving scenario in which the moving object will make a lane change to the right.

If the test data is obtained in S150, in S160, the driving path output device 1200 may output a driving path for testing in the drivable area for testing with reference to the information about the drivable area for testing.

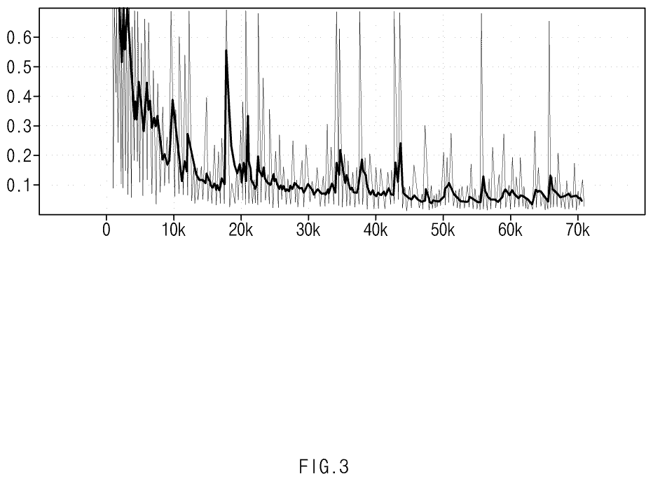

FIG. 3 shows an example of a learning process and a result of a driving path output device according to an example disclosed in the present disclosure.

Referring to FIG. 3, it may be identified that loss gradually decreases as learning progresses and a result loss of learning all of 7582 training data 11 times (epochs) is less than 0.1.

For reference, the learning rate is set to 0.0005, the epoch is set to 11, the number of pieces of training data is set to 7582, and a mean square loss is used as the loss function.

Furthermore, as a result of verifying the trained driving path output device using 1338 pieces of verification data different from the training data, it is identified that a lateral error between 40 prediction points of the proposed driving path and 40 optimal points of the optimal driving path is 18.5 cm on average and the driving path output device generates the same or similar proposed driving path to the optimal driving path.

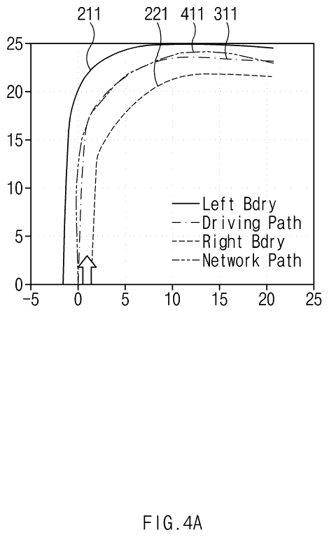

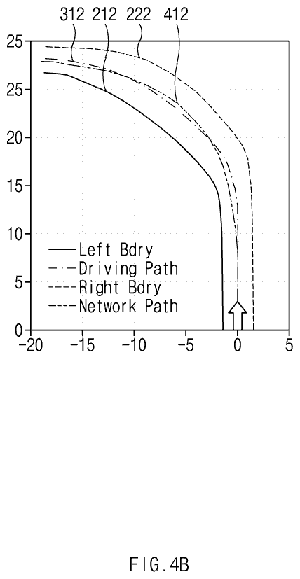

FIGS. 4A and 4B are examples for comparing a proposed driving path output via a driving path output device 1200 trained according to a method with an optimal driving path according to an example disclosed in the present disclosure.

First of all, referring to FIG. 4A illustrating the result of generating a path for a right turn curvature section, the driving path output device 1200 a proposed driving path 411 (e.g., Network Path) including information about 40 prediction points by using a plurality of first boundary points (e.g., 40 first boundary points) on a first boundary line 211 and a plurality of second boundary points (e.g., 40 second boundary points) on a second boundary line 221 as the input and may identify that the position of each of the 40 prediction points is very close to a position of each of the 40 optimal points on an optimal or improved driving path 311 (e.g., Driving Path) corresponding to the proposed driving path 411.

Furthermore, referring to FIG. 4B illustrating the result of generating a path for a left turn curvature section, the driving path output device 1200 may output a proposed driving path 412 (Network Path) including information about 40 prediction points by using a plurality of first boundary points (e.g., 40 first boundary points) on a first boundary line 212 and a plurality of second boundary points (e.g., 40 second boundary points) on a second boundary line 222 as the input and may identify that the position of each of the 40 prediction points is very close to a position of each of the 40 optimal points on an optimal driving path 312 (Driving Path) corresponding to the proposed driving path 412, like FIG. 4A.

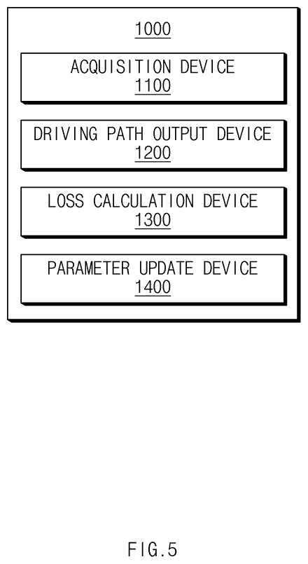

FIG. 5 shows an example of an apparatus 1000 for controlling autonomous driving to an example according disclosed in the present disclosure.

Referring to FIG. 5, the apparatus 1000 for controlling the autonomous driving according to an example disclosed in the present disclosure may include an acquisition device 1100, a driving path output device 1200, a loss calculation device 1300, and a parameter update device 1400.

For example, the acquisition device 1100 may obtain training data including information about a drivable area.

The driving path output device 1200 may output a proposed driving path in the drivable area with reference to the information about the drivable area.

The loss calculation device 1300 may calculate or determine a driving path loss with reference to the proposed driving path and an optimal driving path corresponding to the proposed driving path. For example, the parameters may be machine learning model parameters (e.g., model version and update status, confidence levels of predictions, training data and validation results, anomaly detection and handling, etc.), vehicle positioning parameters (e.g., GPS coordinates, speed and acceleration, heading/direction, vehicle orientation (pitch, roll, yaw), etc.), environmental parameters (e.g., road type (e.g., highway, city street, rural road), road conditions (e.g., dry, wet, icy), traffic conditions (e.g., density, flow rate), weather conditions (e.g., rain, snow, fog), lane boundaries and width, road markings and signs, traffic light status and timing, speed limits and other regulatory signs, etc.), destination and route parameters (e.g., destination coordinates, waypoints along the route, estimated preferred route types (e.g., fastest, shortest, scenic), etc.), obstacle detection parameters (distance to nearest obstacle, type of obstacle (e.g., vehicle, pedestrian, stationary object), obstacle speed and direction, etc.), and communication and connectivity parameters (e.g., v2v (vehicle-to-vehicle) communication status, v2i (vehicle-to-infrastructure) communication status, real-time data streaming capabilities, or cloud-based data storage and processing, etc.).

The parameter update device 1400 may update at least some of parameters of the driving path output device 1200 using the driving path loss.

According to an example disclosed in the present disclosure, because the driving path output device 1200 is trained using training data generated by a quadratic programming scheme based on an optimization algorithm, the driving path output device 1200 may simulate an optimal driving path of the optimization algorithm. In addition, it takes several milliseconds (ms) to generate an optimal driving path depending on an existing optimization algorithm, whereas a calculation time may be greatly reduced because it takes a few microseconds (μs) for the driving path output device 1200 according to an example disclosed in the present disclosure to generate an optimal driving path. As a result, a computing resource which was used to generate an optimal driving path in the past may be used for a task (e.g., a task for safety or driving) except for generating a driving path.

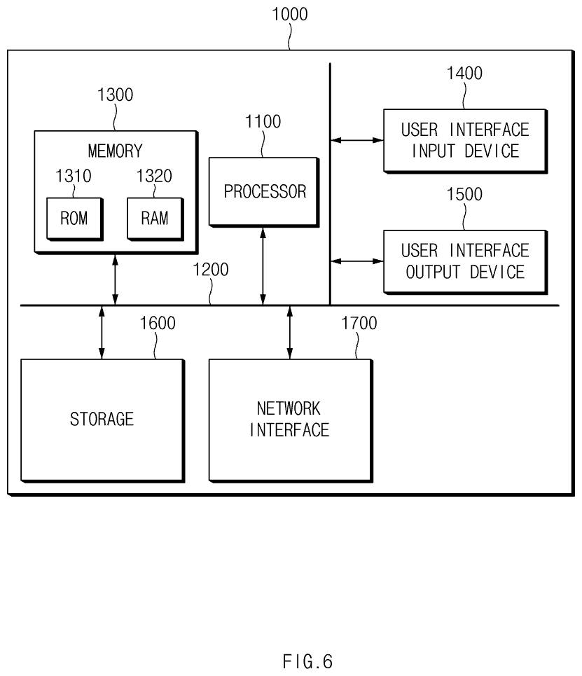

FIG. 6 illustrates a block diagram of a computing system for executing a method for controlling autonomous driving to generate an optimal driving path according to an example disclosed in the present disclosure.

Referring to FIG. 6, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only memory (ROM) and a random access memory (RAM).

Thus, the operations of the methods or algorithms described in connection with the examples disclosed in the present disclosure may be directly implemented with a hardware module, a software module, or the combinations thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM).

The exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as separate components of the user terminal.

The present disclosure has been made to solve the above-mentioned problems occurring in the prior art while advantages achieved by the prior art are maintained intact.

An example of the present disclosure provides a method and an apparatus for controlling autonomous driving to generate an optimal driving path based on machine learning.

Another example of the present disclosure provides a method and an apparatus for controlling autonomous driving to generate an optimal driving path within a short calculation time.

Another example of the present disclosure provides a method and an apparatus for controlling autonomous driving to generate an optimal driving path corresponding to each of various driving environments.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a method for controlling autonomous driving may include obtaining, by an acquisition device, training data including information about a drivable area, outputting, by a driving path output device, a proposed driving path in the drivable area with reference to the information about the drivable area, calculating, by a loss calculation device, a driving path loss based on the proposed driving path and the training data, updating, by a parameter update device, at least some of parameters of the driving path output device using the driving path loss, obtaining, by an acquisition device, test data including information about a drivable area for testing, and outputting, by the driving path output device, a driving path for testing in the drivable area for testing with reference to the information about the drivable area for testing.

In an example, the information about the drivable area may include information about a boundary line of the drivable area.

In an example, the information about the boundary line of the drivable area may include information about a plurality of first boundary points on a first boundary line of the drivable area and a plurality of second boundary points on a second boundary line of the drivable area.

In an example, the method may further include generating, by a training data generation model, the training data including an optimal driving path corresponding to the drivable area, if the information about the drivable area is input, before obtaining the training data.

In an example, the generating of the training data may include generating, by the training data generation model, the optimal driving path based on a quadratic programming scheme.

In an example, the information about the drivable area may be obtained from at least a portion of actual driving data generated as a moving object travels on a road and virtual driving data generated as a driving simulation process is performed.

In the method may further include generating, by a test data generator, the test data including the information about the drivable area for testing with reference to at least a portion of a driving image obtained from an image sensor and high definition map information, before obtaining the test data.

In an example, the generating of the test data may include additionally referencing, by the test data generator, driving scenario information to generate the test data including the information about the drivable area for testing.

According to another example of the present disclosure, an apparatus for controlling autonomous driving may include a memory storing computer-executable instructions and at least one processor that accesses the memory and executes the instructions. The at least one processor may obtain training data including information about a drivable area by means of an acquisition device and obtain test data including information about a drivable area for testing by means of the acquisition device, may output a proposed driving path in the drivable area with reference to the information about the drivable area by means of a driving path output device and output a driving path for testing in the drivable area for testing with reference to the information about the drivable area for testing by means of the driving path output device, may calculate a driving path loss based on the proposed driving path and the training data by means of a loss calculation device, and may update at least some of parameters of the driving path output device using the driving path loss by means of a parameter update device.

In an example, the information about the drivable area may include information about a boundary line of the drivable area.

In an example, the information about the boundary line of the drivable area may include information about a plurality f first boundary points on a first boundary line of the drivable area and a plurality of second boundary points on a second boundary line of the drivable area.

In an example, the apparatus may further include a training data generation model for generating the training data including an optimal driving path corresponding to the drivable area, if the information about the drivable area is input.

In an example, the training data generation model may generate the optimal driving path based on a quadratic programming scheme.

In an example, the information about the drivable area may be obtained from at least a portion of actual driving data generated as a moving object travels on a road and virtual driving data generated as a driving simulation process is performed.

According to the present disclosure, the method and the apparatus for controlling the autonomous driving may be provided to generate an optimal driving path based on machine learning.

According to the present disclosure, the method and the apparatus for controlling the autonomous driving may be provided to generate an optimal driving path within a short calculation time.

According to the present disclosure, the method and the apparatus for controlling the autonomous driving may be provided to generate an optimal driving path corresponding to each of various driving environments.

In addition, various effects ascertained directly or indirectly through the present disclosure may be provided.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims. Therefore, the examples of the present disclosure are provided to explain the spirit and scope of the present disclosure, but not to limit them, so that the spirit and scope of the present disclosure is not limited by the examples. The scope of the present disclosure should be construed on the basis of the accompanying claims, and all the technical ideas within the scope equivalent to the claims should be included in the scope of the present disclosure.

What is claimed is:

1. A method performed by a vehicle for controlling autonomous driving of the vehicle, the method comprising:
obtaining training data comprising information about a first drivable area;
outputting, based on the information about the first drivable area, a first driving path in the first drivable area;
determining, based on the first driving path and the training data, a driving path loss;
updating, based on the driving path loss, at least one of parameters associated with the outputting the first driving path;
obtaining, based on the updating the at least one of parameters, test data comprising information about a second drivable area for testing;
outputting, based on the information about the second drivable area for testing, a second driving path for testing in the second drivable area for testing; and
controlling, based on the second driving path for testing, autonomous driving of the vehicle.

2. The method of claim 1, wherein the information about the first drivable area comprises information about a boundary line of the first drivable area.

3. The method of claim 2, wherein the information about the boundary line of the first drivable area comprises information about:
a plurality of first boundary points on a first boundary line of the first drivable area; and
a plurality of second boundary points on a second boundary line of the first drivable area.

4. The method of claim 1, further comprising:
generating, based on a training data generation model and the information about the first drivable area, the training data, wherein the training data comprises an improved driving path corresponding to the first drivable area, and wherein the information about the first drivable area is input before obtaining the training data.

5. The method of claim 4, wherein the generating the training data comprises generating, based on a quadratic programming scheme, the improved driving path.

6. The method of claim 4, wherein the information about the first drivable area is obtained based on at least a portion of:
first driving data generated as a moving object travels on a road; and
second driving data generated based on a driving

7. The method of claim 1, wherein the obtaining the test data comprises generating, based on at least a portion of a driving image obtained from an image sensor and high definition map information, the test data, wherein the at least the portion of the driving image is obtained before obtaining the test data.

8. The method of claim 7, wherein the generating the test data comprises generating, based on driving scenario information, the test data.

9. The method of claim 1, further comprising:
outputting coordinates of prediction points on the first driving path, wherein the driving path loss is associated with a value representing how far the prediction points are from target values.

10. An apparatus for controlling autonomous driving of a vehicle, the apparatus comprising:
at least one processor; and
a memory storing instructions, when executed by the at least one processor, cause the apparatus to:
obtain training data comprising information about a first drivable area;
obtain test data comprising information about second drivable area for testing;
output, based on the information about the first drivable area, a first driving path in the first drivable area;
output, based on the information about the second drivable area for testing, a second driving path for testing in the second drivable area;
determine, based on the first driving path and the training data, a driving path loss;
update, based on the driving path loss, at least one of parameters associated with outputting the first driving path; and
control, based on the at least one of parameters, autonomous driving of the vehicle.

11. The apparatus of claim 10, wherein the information about the first drivable area comprises information about a boundary line of the first drivable area.

12. The apparatus of claim 11, wherein the information about the boundary line of the first drivable area comprises information about:
a plurality of first boundary points on a first boundary line of the first drivable area; and
a plurality of second boundary points on a second boundary line of the first drivable area.

13. The apparatus of claim 10, wherein the instructions, when executed by the at least one processor, cause the apparatus to:
generate, based on a training data generation model and the information about the first drivable area, the training data, wherein the training data comprises an improved driving path corresponding to the first drivable area, and wherein the information about the first drivable area is input before obtaining the training data.

14. The apparatus of claim 13, wherein instructions, when executed by the at least one processor, cause the apparatus to:
generate, based on a quadratic programming scheme, the improved driving path.

15. The apparatus of claim 13, wherein the information about the first drivable area is obtained based on at least a portion of:
first driving data generated as a moving object travels on a road; and
second driving data generated based on a driving

16. The apparatus of claim 10, wherein the obtaining the test data comprises generating, based on at least a portion of a driving image obtained from an image sensor and high definition map information, the test data, wherein the at least the portion of the driving image is obtained before obtaining the test data.

17. The apparatus of claim 10, wherein instructions, when executed by the at least one processor, cause the apparatus to obtain the test data by generating, based on driving scenario information, the test data.

18. The apparatus of claim 10, wherein instructions, when executed by the at least one processor, cause the apparatus to obtain the test data by obtaining, based on the at least one of parameters associated with outputting the first driving path, the test data.

19. The apparatus of claim 11, wherein the information about the boundary line of the first drivable area comprises information about coordinates of boundary points in the boundary line.

20. The apparatus of claim 10, wherein instructions, when executed by the at least one processor, cause the apparatus to output coordinates of prediction points on the first driving path.
